(19) United States
(12) Patent Application Publication
(10) Pub. No.: US 2026/0036842 A1
(43) Pub. Date: Feb. 5, 2026

(54) DISPLAY DEVICE

(71) Applicant: LG Display Co., Ltd., Seoul (KR)

(72) Inventors: YoungJin JUNG, Ansan-si (KR); JinSoo KIM, Seoul (KR); YeongHo KIM, Gimpo-si (KR)

(73) Assignee: LG Display Co., Ltd., Seoul (KR)

(21) Appl. No.: 19/286,027

(22) Filed: Jul. 30, 2025

(30) Foreign Application Priority Data
Jul. 31, 2024 (KR) 10-2024-0102108

(51) Int. Cl. G02F 1/1335; G02F 1/1339

(52) U.S. Cl. CPC G02F 1/133512; G02F 1/133528; G02F 1/1339

(57) ABSTRACT

A display device can include a polarizer disposed on an uppermost layer of the display device; a display panel having a upper surface attached to the polarizer; a light shielding layer formed on an edge of a rear surface of the polarizer; a bottom cover disposed under the display panel and accommodating the display panel; and a guide panel disposed on a rear surface and a side surface of the display panel. The guide panel includes a horizontal portion and a side portion, the horizontal portion protruding from the side portion. The polarizer extends to a top surface of the side portion of the guide panel. By doing this, the overall thickness of the display device is reduced to implement a slim design.

### CROSS-REFERENCE TO RELATED APPLICATIONS

This application claims priority to Korean Patent Application No. 10-2024-0102108 filed on Jul. 31, 2024, in the Republic of Korea, the entire disclosure of which is incorporated by reference.

### BACKGROUND

### Field

The present disclosure relates to a display device, and more particularly, to a display device with a narrow bezel structure.

### Description of the Related Art

Currently, as the world enters a full-scale information era, a field of a display device which visually expresses electrical information signals has been rapidly developed and studies are continued to improve performances of various display devices such as a thin-thickness, a light weight, and low power consumption.

As a representative display device, there are a liquid crystal display device (LCD), an electro-wetting display device (EWD), and an organic light emitting display device (OLED).

The liquid crystal display device includes an liquid crystal display panel in which an upper substrate and a lower substrate are bonded with a liquid crystal layer interposed therebetween, a driving circuit which applies a predetermined driving signal to a liquid crystal display panel, and an assembly component which assembles the liquid crystal display panel and the driving circuit and can further include various components according to an application field, such as a computer monitor or a television.

### SUMMARY OF THE DISCLOSURE

An object to be achieved by the present disclosure is to provide a display device in which a step of a front edge portion is removed while minimizing a width of a front edge.

Another object to be achieved by the present disclosure is to provide a display device which addresses or overcomes limitations of increased cost, weight, and thickness due to the usage of a cover glass.

Another object to be achieved by the present disclosure is to provide a display device in which light leaked toward a top of a guide panel is blocked.

Objects of the present disclosure are not limited to the above-mentioned objects, and other objects, which are not mentioned above, can be clearly understood by those skilled in the art from the following descriptions.

In order to achieve the objects as described above, according to an aspect of the present disclosure, a display device can include: a polarizer disposed on an uppermost layer of the display device; a display panel having a upper surface attached to the polarizer; a light shielding layer formed on an edge of a rear surface of the polarizer; a bottom cover disposed under the display panel and accommodating the display panel; and a guide panel disposed on a rear surface and a side surface of the display panel, wherein the guide panel includes a horizontal portion and a side portion, the horizontal portion protruding from the side portion, and wherein the polarizer extends to a top surface of the side portion of the guide panel.

According to another aspect of the present disclosure, a display device can include: a display panel for displaying an image; a bottom cover disposed below the display panel; a guide panel surrounding side surfaces of the display panel and the bottom cover; an optical member positioned on a top surface of the display panel and extending above the guide panel; and a light shielding layer disposed on an edge of a rear surface of the optical member.

Other detailed matters of the embodiments of the present disclosure are included in the detailed description and the drawings.

According to aspects of the present disclosure, a film, such as a polarizer or an optical film, is used rather than a cover glass so that an overall thickness of the display device is reduced to implement a slim design. Therefore, a slim and simple design can be implemented.

According to aspects of the present disclosure, a step of an upper side of the guide panel is removed and a film, such as a polarizer or an optical film, extends toward a top of the guide panel to remove a gap formed with the guide panel and reduce a width of the guide panel. Therefore, a step of an edge portion is removed while minimizing a width of a front edge to improve the aesthetics in terms of design.

According to aspects of the present disclosure, a colored light shielding layer is formed on an edge of a rear surface of a film, such as a polarizer or an optical film to block light which is leaked to the upper portion of the guide panel so that the aesthetics can be improved by suppressing the damage of the design due to the light leakage.

According to aspects of the present disclosure, a foam pad extends to a side surface of the display panel to block the light leakage and improve an adhesive strength between a film, such as a polarizer or an optical film, and a guide panel.

According to aspects of the present disclosure, a design of an upper portion of the guide panel is changed to suppress the damage which is applied to the film, such as a polarizer or an optical film, due to the external shock and make the exterior design more beautiful.

The effects according to the present disclosure are not limited to the contents exemplified above, and more various effects are included in the present specification.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a front view of a display device according to a first embodiment of the present disclosure;

FIG. 2 is a front view of a display unit according to a first embodiment of the present disclosure;

FIG. 3 is a cross-sectional view taken along I-I′ of FIG. 2;

FIGS. 4A to 4C are other examples of cross-sectional views taken along I-I′ of FIG. 2;

FIG. 5 is a front view of a display unit according to a second embodiment of the present disclosure;

FIG. 6 is an exploded perspective view illustrating a part of a display unit of FIG. 5;

FIG. 7 is a cross-sectional view taken along II-II′ of FIG. 5;

FIGS. 8A and 8B are cross-sectional views taken along III-III′ of FIG. 5;

FIG. 9A is a perspective view illustrating a part of a first foam pad of FIG. 6;

FIG. 9B is a perspective view illustrating a part of a second foam pad of FIG. 6;

FIG. 10 is a cross-sectional view of a display device according to a third embodiment of the present disclosure;

FIG. 11 is a cross-sectional view of a display device according to a fourth embodiment of the present disclosure;

FIG. 12 is a cross-sectional view of a display device according to a fifth embodiment of the present disclosure;

FIG. 13A is a cross-sectional view of a display device according to a sixth embodiment of the present disclosure; and

FIG. 13B is a view enlarging a part C of FIG. 13A.

### DETAILED DESCRIPTION OF THE EMBODIMENTS

Advantages and characteristics of the present disclosure and a method of achieving the advantages and characteristics will be clear by referring to embodiments described below in detail together with the accompanying drawings. However, the present disclosure is not limited to the embodiments disclosed herein but will be implemented in various forms. The embodiments are provided by way of example only so that those skilled in the art can fully understand the disclosures of the present disclosure and the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the specification. Further, in the following description of the present disclosure, a detailed explanation of known related technologies can be omitted to avoid unnecessarily obscuring the subject matter of the present disclosure. The terms such as “including,” “having,” and “consist of” used herein are generally intended to allow other components to be added unless the terms are used with the term “only”. Any references to singular can include plural unless expressly stated otherwise.

Components are interpreted to include an ordinary error range even if not expressly stated.

When the position relation between two parts is described using the terms such as “on”, “above”, “below”, and “next”, one or more parts can be positioned between the two parts unless the terms are used with the term “immediately” or “directly”.

When an element or layer is disposed “on” another element or layer, another layer or another element can be interposed directly on the other element or therebetween.

Although the terms “first”, “second”, and the like are used for describing various components, these components are not confined by these terms. These terms are merely used for distinguishing one component from the other components. Therefore, a first component to be mentioned below can be a second component in a technical concept of the present disclosure. Further, the term “can” fully encompasses all the meanings and coverages of the term “may” and vice versa.

Like reference numerals generally denote like elements throughout the specification.

A size and a thickness of each component illustrated in the drawing are illustrated for convenience of description, and the present disclosure is not limited to the size and the thickness of the component illustrated.

The features of various embodiments of the present disclosure can be partially or entirely adhered to or combined with each other and can be interlocked and operated in technically various ways, and the embodiments can be carried out independently of or in association with each other.

Hereinafter, various embodiments of the present disclosure will be described in detail with reference to the drawings. All the components of each display device/apparatus according to all embodiments of the present disclosure are operatively coupled and configured.

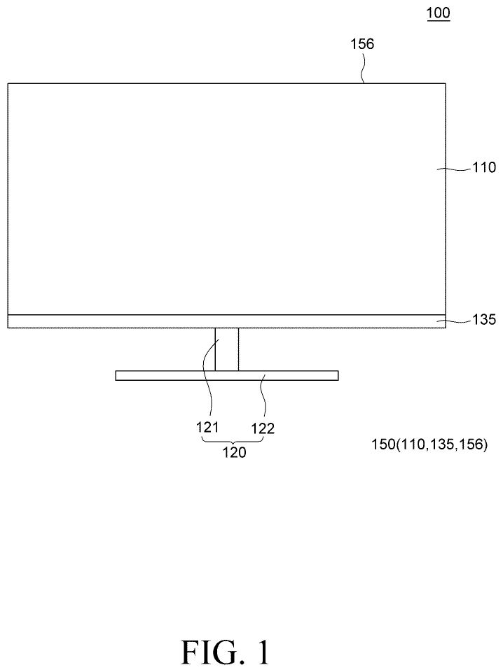

FIG. 1 is a front view of a display device according to a first embodiment of the present disclosure. Particularly, FIG. 1 illustrates a display device with a stand fixing structure as an example, but the present disclosure is not limited thereto.

Referring to FIG. 1, a display device 100 according to an embodiment of the present disclosure includes a display panel 110 which displays an image and a stand unit 120 which is installed below the display panel 110 to support a load of the display panel 110 and configures one set.

The display device 100 having a stand fixing structure is used as a stand structure to be equipped on a bottom surface of a predetermined space, such as a computer monitor or a television.

The display device 100 according to the first embodiment of the present disclosure can further include a cover unit which encloses an outside of the display panel 110 and for the convenience of description, the display panel 110 and the cover unit are referred to as a display unit 150.

The cover unit can include a front cover 135 which covers a part of a lower side of the display panel 110, a bottom cover which encloses a rear surface and a side surface of the display panel 110, and a guide panel. Further, the cover unit can further include a top case which encloses the display panel 110 along the front edge of the display panel 110 to be coupled to a side surface of the guide panel. In the present disclosure, in order to implement a narrow bezel, a top case is omitted.

The display panel 110 is a panel for displaying images to a user.

At this time, in the display panel 110, a display element which displays images, a driving element which drives the display element, and wiring lines which transmit various signals to the display element and the driving element can be disposed. The display element can be defined in various manners depending on the type of the display panel 110 and for example, when the display panel 110 is a liquid crystal display panel, the display panel 110 can be configured to include an upper substrate and a lower substrate and a liquid crystal layer interposed between the upper substrate and the lower substrate.

Hereinafter, it is assumed that the display panel 110 is a liquid crystal display panel, but the present disclosure is not limited thereto. For example, when the display panel 110 is an organic light emitting display panel, the display element can be an organic light emitting diode which includes an anode, an organic emission layer, and a cathode.

As described above, the display panel 110 can be configured by the upper substrate, the lower substrate, and the liquid crystal layer interposed between the upper substrate and the lower substrate. The liquid crystal display device is a flat panel display device which displays an image by adjusting a transmittance of light in accordance with alignment of liquid crystal molecules of the liquid crystal layer when light transmits.

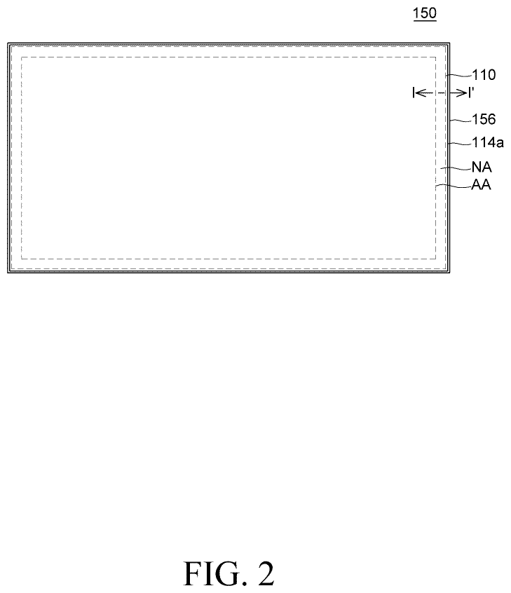

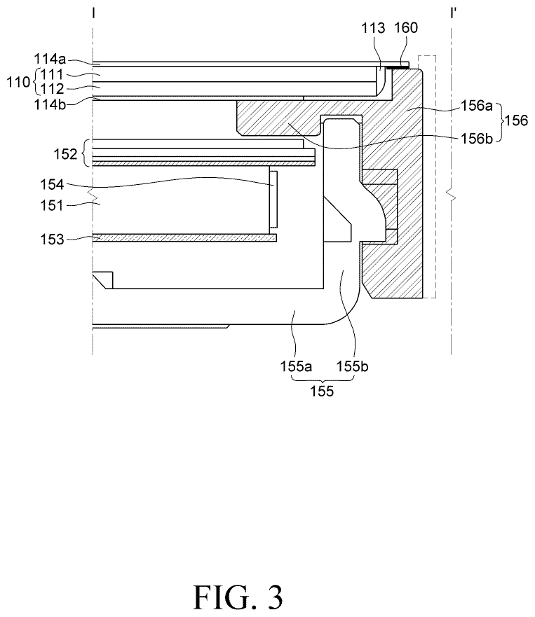

Further, a backlight unit which supplies light and a bottom cover in which the backlight unit and the display panel 110 are accommodated can be disposed below the display panel 110. For example, the backlight unit can include a light source and an optical unit which supplies light generated from the light source to the display panel 110. Some components of the bottom cover and the backlight unit can be fixed by the guide panel 156 disposed below the display panel 110. The display panel 110 will be described below in more detail with reference to FIGS. 2 and 3.

In the meantime, the stand unit 120 supports the display unit 150 to stand upright on a flat table.

For example, the stand unit 120 can be configured by a fixing plate, a tilt adjusting unit, a support unit 121, and a base plate 122. The fixing plate is coupled to a rear surface of the bottom cover, the tilt adjusting unit is integrally formed with the fixing plate to adjust a vertical angle (tilt) of the display unit 150, and the support unit 121 is coupled to the tilt adjusting unit to support the display unit 150. Further, the base plate 122 can be provided on a bottom surface of the support unit 121 to support a load of the display unit 150.

The fixing plate can have a plurality of through holes to be fastened on the rear surface of the bottom cover through a screw, but is not limited thereto.

In the meantime, according to the first embodiment of the present disclosure, a cover glass on a top layer of the display unit is removed and is replaced with a polarizer to reduce an overall thickness of the display device, thereby implementing a slim design. Further, a step of an upper portion of the guide panel is removed and the polarizer extends toward the upper portion of the guide panel to remove a gap formed with the guide panel and reduce a width of the guide panel, which will be described in detail with reference to FIGS. 2 and 3.

FIG. 2 is a front view of a display unit according to a first embodiment of the present disclosure.

FIG. 3 is a cross-sectional view taken along I-I′ of FIG. 2.

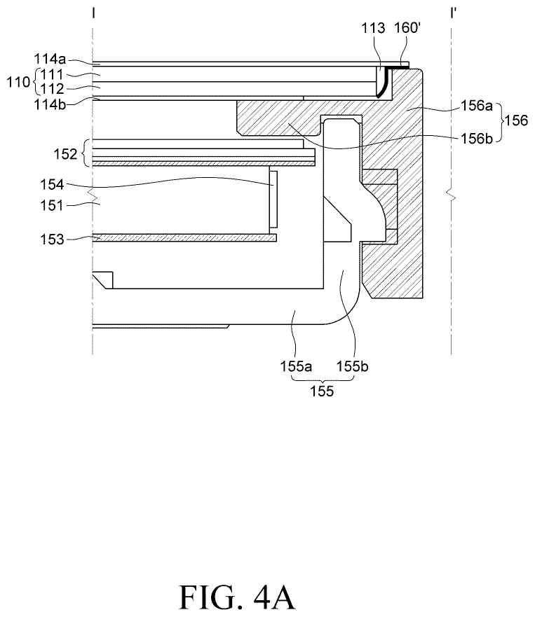

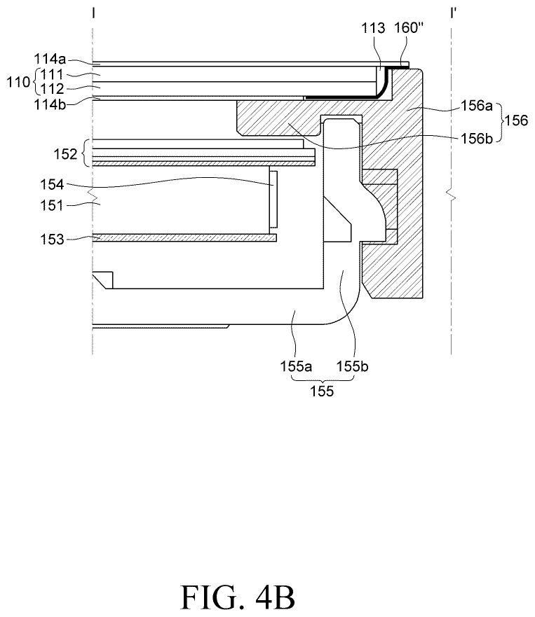

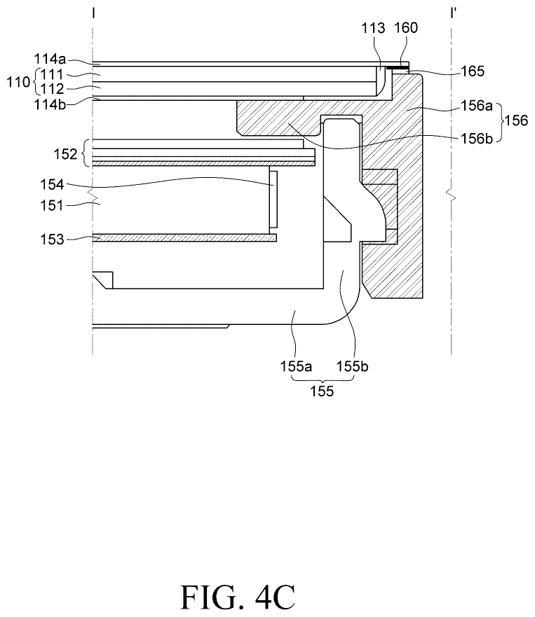

FIGS. 4A to 4C are other examples of cross-sectional views taken along I-I′ of FIG. 2.

In FIGS. 4A to 4C, except that light shielding layers 160′ and 160″ have different shapes or an adhesive layer 165 is added, the other configuration is substantially the same as the first embodiment of FIG. 3.

Referring to FIGS. 2 and 4A to 4C, the display unit 150 of the first embodiment can include a display panel 110, a bottom cover 155, a guide panel 156, and a backlight unit. The display panel 110 displays images and the bottom cover 155 is disposed below the display panel 110. The guide panel 156 is disposed on a rear surface and a side surface of the display panel 110 to enclose side surfaces of the display panel 110 and the bottom cover 155 and the backlight unit is accommodated in the bottom cover 155.

First, the display panel 110 can be configured by upper and lower substrates 111 and 112 and a liquid crystal layer interposed between the upper and lower substrates 111 and 112.

Hereinafter, it is assumed that the display panel 110 is a liquid crystal display panel, but as described above, the present disclosure is not limited thereto. If the display panel 110 is an organic light emitting display panel, the display element can be an organic light emitting diode which includes an anode, an organic emission layer, and a cathode.

For example, under the assumption of an active matrix type, a plurality gate lines and a plurality of data lines intersect to define sub pixels on an inner surface of the lower substrate 112 which is generally referred to as an array substrate or a first substrate. Further, the thin film transistor is provided in every intersection to be connected to a pixel electrode formed in each sub pixel.

Further, red (R), green (G), and blue (B) color filters corresponding to the sub pixels, a black matrix which encloses the color filters, and blocks non-display element, such as the gate lines, the data lines, and the thin film transistor, and a common electrode which covers them are provided on an inner surface of the upper substrate 111. The upper substrate is referred to as a color filter substrate or a second substrate. At this time, when the liquid crystal display panel is an in-plane switching (IPS) mode or a fringe field switching (FFS) mode, the common electrode can be formed on the lower substrate 112.

Further, upper and lower polarizers 114a and 114b which selectively transmit only specific light can be attached onto outer surfaces of the upper and lower substrates 111 and 112.

A sealing member 113, such as a sealant, can be provided on edge side surfaces of the upper and lower substrates 111 and 112 excluding the lower side to seal the side surfaces of the upper and lower substrates 111 and 112. The sealing member 113 also serves to fix the upper and lower substrates 111 and 112 so that a top case of the related art can be omitted and thus a bezel width can be reduced. However, the present disclosure is not limited thereto and the sealing member 113 may not be provided.

The display panel 110 can include an active area AA and a non-active area NA.

The active area AA is an area where images are displayed in the display panel 110.

In the active area AA, a plurality of sub pixels which configures the plurality of pixels and a circuit for driving the plurality of sub pixels can be disposed. The plurality of sub pixels is minimum units which configure the active area AA and a display element can be disposed in each of the plurality of sub pixels. The plurality of sub pixels can configure a pixel. For example, in each of the plurality of sub pixels, a thin film transistor which is a switching element can be disposed, but is not limited thereto. Further, a circuit for driving the plurality of sub pixels can include a driving element and a wiring line. For example, the circuit can be configured by a thin film transistor, a storage capacitor, a gate line, and a data line, but is not limited thereto.

The non-active area NA is an area where no image is displayed.

Even though in FIG. 2, it is illustrated that the non-active area NA encloses a quadrangular active area AA, shapes and placements of the active area AA and the non-active area NA are not limited to the example illustrated in FIG. 2. In other words, the active area AA and the non-active area NA can have shapes suitable for a design of an electronic device including the display device 100. Another shape of the active area AA can be a pentagon, a hexagon, a circle, or an oval.

In the non-active area NA, various wiring lines and circuits for driving the liquid crystal display element of the active area AA can be disposed. For example, in the non-active area NA, a wiring line which transmits signals to the plurality of sub pixels and circuits of the active area AA or a driving IC such as a gate driver IC or a data driver IC can be disposed, but it is not limited thereto.

The display panel 110 can further include various additional elements to generate various signals or drive the pixel in the active area AA. The additional elements for driving the pixels can include an inverter circuit, a multiplexer, or an electrostatic discharge (ESD) circuit. The display panel 110 can further include an additional element associated with a function other than a pixel driving function. For example, the display panel 110 can include additional elements which provide a touch sensing function, a user authentication function (for example, fingerprint recognition), a multilevel pressure sensing function, or a tactile feedback function. The additional elements can be located in an external circuit which is connected to the non-active area NA and/or the connecting interface.

The display unit 150 can further include a flexible film and a source printed circuit board (not illustrated).

First, the flexible film is a film in which various components are disposed on a base film having a ductility. Specifically, the flexible film is a film which supplies a signal to the plurality of sub pixels and the circuits of the active area AA and can be electrically connected to the display panel 110. The flexible film is disposed at one end of the non-active area NA of the display panel 110 to supply a power voltage or a data voltage to the plurality of sub pixels and the circuits of the active area AA. In the meantime, the number of flexible films can vary depending on the design, but is not limited thereto.

For example, a driving IC such as a data driver IC can be disposed in the flexible film. The driving IC is a component which processes a data signal for displaying images and a driving signal for processing the data signal. The driving IC can be disposed by a chip on glass (COG), a chip on film (COF), or a tape carrier package (TCP) depending on a mounting method.

Further, the source printed circuit board is disposed at one end of the flexible film to be connected to the flexible film. The source printed circuit board is a component which supplies signals to the driving IC. The source printed circuit board can supply various signals such as a driving signal or a data signal to the driving IC. For example, a data driver which generates data signals can be mounted in the source printed circuit board and the generated data signal can be supplied to the plurality of sub pixels and the circuit of the display panel 110 through the flexible film. The number of source printed circuit boards can vary depending on the design, but is not limited thereto.

In the meantime, a backlight unit which supplies light, a bottom cover 155 which accommodates the backlight unit and the display panel 110, and a guide panel 156 can be disposed below the display panel 110 configured as described above.

The backlight unit can include an LED array assembly including a light source which is accommodated in the bottom cover 155, a light guide plate 151, a reflective plate 153, a plurality of optical sheets 152, and a side reflective plate 154. The light guide plate 151 supplies a surface light source to the display panel 110 through the light source, the reflective plate 153 is disposed on a rear surface of the light guide plate 151, and the plurality of optical sheets 152 is disposed on a top surface of the light guide plate 151. Further, the side reflective plate 154 is disposed on a side surface of the light guide plate 151 excluding a lower side in which the LED array assembly is disposed. However, the backlight unit is not limited thereto.

In the meantime, the light that proceeds to the light incident surface of the light guide plate 151 can be emitted toward the upper portion where the display panel 110 is disposed while passing through several total reflection processes inside the light guide plate 151. At this time, the light guide plate 151 can include a pattern with a specific shape on a rear surface to supply uniform surface light sources. The pattern can be configured with various patterns, such as an elliptical pattern, a polygonal pattern, or a hologram pattern, to guide the light incident therein and the pattern can be formed on a lower surface of the light guide plate 151 by a printing method or an injecting method.

The optical sheet 152 can be configured to include at least one diffusion sheet and prism sheet, among a lower diffusion sheet, a lower prism sheet, an upper prism sheet, and an upper diffusion sheet.

Further, for example, the light source can be configured as an LED package in which LEDs are mounted and can be disposed in a light incident area of the light guide plate 151. Further, the LED array assembly can include an LED package and an LED printed circuit board.

The bottom cover 155 of the first embodiment of the present disclosure can accommodate the display panel 110 and the backlight unit. To this end, the bottom cover 155 of the first embodiment of the present disclosure can be configured to include a lower portion 155a which supports the backlight unit and a side portion 155b which is vertically bent from the edge of the lower portion 155a. The side portion 155b of the bottom cover 155 can be bent in an “L” shape to accommodate the backlight unit.

Further, some configurations of the backlight unit are fixed by the guide panel 156 and the guide panel 156 can enclose and fix the side surfaces of the display panel 110 and the bottom cover 155.

The guide panel 156 can be formed with a rectangular frame shape to have an inverted L-shaped cross-section.

For example, the guide panel 156 of the first embodiment of the present disclosure can include a side portion 156a and a horizontal portion 156b. The side portion 156a is disposed on side surfaces of the display panel 110 and the bottom cover 155 to enclose the side surfaces of the display panel 110 and the bottom cover 155. The horizontal portion 156b extends between the display panel 110 and the optical sheet 152 from the side portion 156a to fix the optical sheet 152. At this time, the side portion 156a of the guide panel 156 can protrude vertically from the horizontal portion 156b so as to enclose the side surface of the display panel 110.

An edge of a rear surface of the display panel 110 can be seated in the horizontal portion 156b of the guide panel 156. For example, the display panel 110 can be attached (seated) to the horizontal portion 156b of the guide panel 156 by means of an adhesive tape or a foam pad. However, the present disclosure is not limited thereto and the adhesive tape or the foam pad can be omitted.

The adhesive tape or the foam pad can have a frame shape along left, right, and upper edges excluding a lower edge of the display panel 110, but is not limited thereto.

As described above, the first embodiment of the present disclosure forms an outer appearance with two configurations of the guide panel 156 and the bottom cover 155.

Further, according to the first embodiment of the present disclosure, a film type upper polarizer 114a is disposed on an uppermost layer of the display unit 150, instead of the cover glass, to reduce the overall thickness of the display device 100 to implement a slim design. Therefore, a slim and simple design can be implemented. Further, the cover glass is omitted to save the cost and the cover glass, and the foam pad are omitted to reduce the overall thickness by 2 mm or more as compared with the existing product.

Further, in the guide panel 156 according to the first embodiment of the present disclosure, a step of the upper side is removed (see the dotted line of FIG. 3) and the upper polarizer 114a extends to the top of the guide panel 156 to remove the gap between the guide panel 156 and the upper polarizer 114a. Further, the width of the guide panel 156 can be reduced. Therefore, a step of the edge portion of the display unit 150 is removed while minimizing a width of a front edge to improve the aesthetics in terms of design. The guide panel with the existing structure has a step on an upper portion to seat the cover glass, which damages the design and the width of the guide panel is increased and the light can be leaked through the gap between the cover glass and the step. In the meantime, according to the first embodiment of the present disclosure, when the film type upper polarizer 114a extends to the upper portion of the guide panel 156, a step structure of the upper portion of the guide panel 156 for seating the upper polarizer 114a is not necessary.

As described above, the upper polarizer 114a of the first embodiment of the present disclosure extends to the upper portion of the guide panel 156 so as to cover the sealing member 113 to have an area larger than the display panel 110. Further, the upper step of the side portion 156a of the guide panel 156 is removed to remove the gap between the upper polarizer 114a and the side portion 156a of the guide panel 156.

At this time, the upper polarizer 114a can be referred to as an optical member.

According to the first embodiment of the present disclosure, a colored light shielding layer 160 is formed on an edge of a rear surface of the upper polarizer 114a to block light which is leaked to the upper portion of the guide panel 156 so that the aesthetics can be improved by suppressing the damage of the design due to the light leakage.

For example, the light shielding layer 160 can have a frame shape along the edge of the rear surface of the upper polarizer 114a (see FIG. 3), but is not limited thereto.

Further, for example, a light shielding layer 160′ extends toward the side surface of the display panel 110 so as to completely cover the outside of the sealing member 113 (see FIG. 4A), but is not limited thereto.

Further, for example, a light shielding layer 160″ can extend toward the rear surface of the display panel 110 so as to cover the edge of the rear surface of the upper polarizer 114a, the outside of the sealing member 113, and the edge of the rear surface of the lower substrate 112 (see FIG. 4B), but is not limited thereto. At this time, for example, the light shielding layer 160″ extends toward the rear surface of the display panel 110 to overlap the side portion 155b of the bottom cover 155, but is not limited thereto.

For example, the light shielding layers 160, 160′, and 160″ can be formed by printing with black ink, but is not limited thereto.

Further, for example, an adhesive layer 165 can be further disposed between the edge of the rear surface of the upper polarizer 114a and the top surface of the side portion 156a of the guide panel 156 (see FIG. 4C), but is not limited thereto. For example, the adhesive layer 165 can be disposed between the light shielding layer 160 on the edge of the rear surface of the upper polarizer 114a and the top surface of the side portion 156a of the guide panel 156.

In the meantime, according to the present disclosure, an “L”-shaped foam pad is disposed between the display panel and the guide panel to block the light leakage and improve the adhesive strength between the film, such as the polarizer or the optical film and the guide panel. This will be described in detail with reference to the drawings.

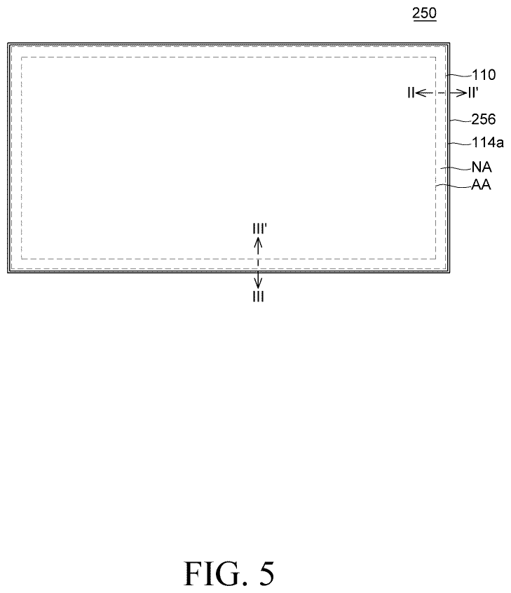

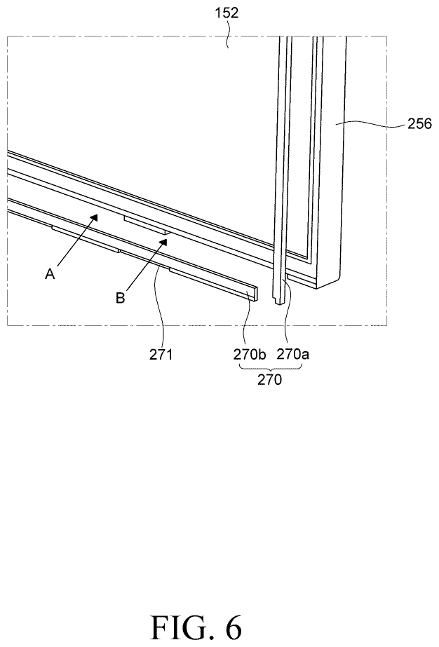

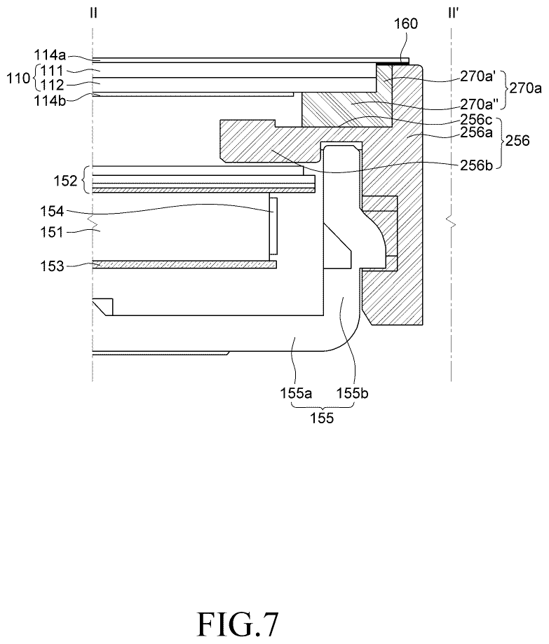

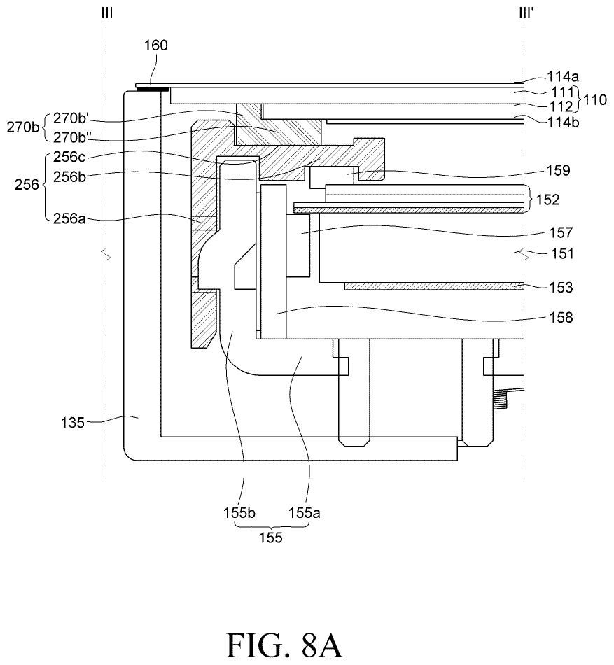

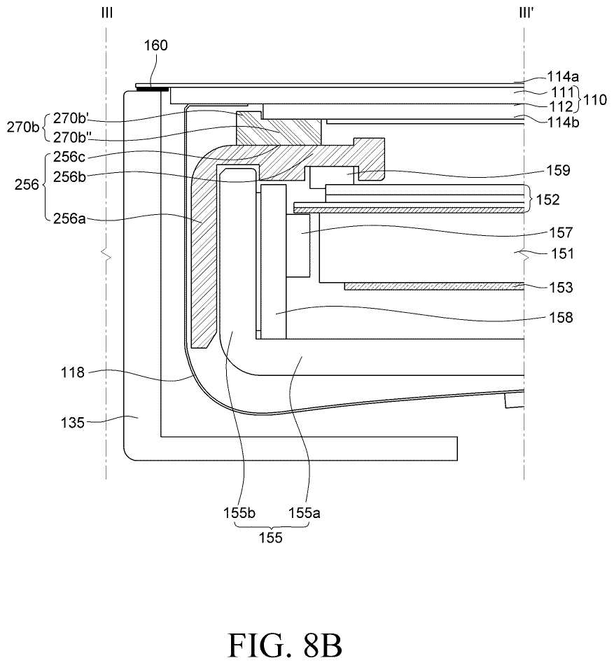

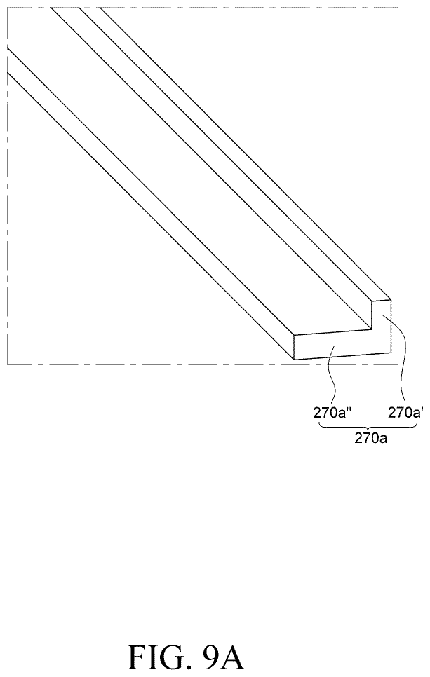

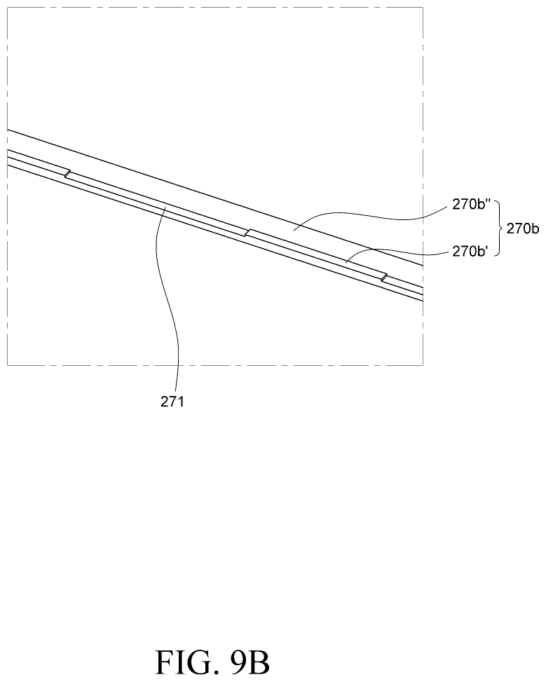

FIG. 5 is a front view of a display unit according to a second embodiment of the present disclosure. FIG. 6 is an exploded perspective view illustrating a part of a display unit of FIG. 5. FIG. 7 is a cross-sectional view taken along II-II′ of FIG. 5. FIGS. 8A and 8B are cross-sectional views taken along III-III′ of FIG. 5. FIG. 9A is a perspective view illustrating a part of a first foam pad of FIG. 6. FIG. 9B is a perspective view illustrating a part of a second foam pad of FIG. 6.

Particularly, FIG. 6 is an exploded perspective view illustrating the fastening of a guide panel 256 and a foam pad 270 of a right lower end of the display unit 250 of FIG. 5.

FIG. 7 illustrates a cross-section of a right side of the display unit 250 of FIG. 5 and FIGS. 8A and 8B illustrate a cross-section of a lower side of the display unit 250 of FIG. 5 as an example.

FIG. 8A illustrates a cross-section of the display unit 250 in a direction A of FIG. 6 and FIG. 8B illustrates a cross-section of the display unit 250 in a direction B of FIG. 6 as an example.

The second embodiment of the present disclosure of FIGS. 5 to 9B is different from the above-described first embodiment of FIGS. 1 to 3 in that an “L”-shaped foam pad 270 is disposed between the display panel 110 and the guide panel 256, but the other configurations are substantially the same. Accordingly, a redundant description will be omitted. Here, the description for the same reference numeral can refer to FIGS. 1 to 4C.

Referring to FIGS. 5 to 9B, the display unit 250 of the second embodiment can include a display panel 110, a bottom cover 155, a guide panel 256, and a backlight unit. The display panel 110 displays images and the bottom cover 155 is disposed below the display panel 110. The guide panel 256 is disposed on a rear surface and a side surface of the display panel 110 to enclose side surfaces of the display panel 110 and the bottom cover 155 and the backlight unit is accommodated in the bottom cover 155.

The display panel 110 can be configured by upper and lower substrates 111 and 112 and a liquid crystal layer interposed between the upper and lower substrates 111 and 112.

Upper and lower polarizers 114a and 114b which selectively transmit only specific light can be attached onto outer surfaces of the upper and lower substrates 111 and 112.

According to the second embodiment, a sealing member and a top case on the side surfaces of the upper and lower substrates 111 and 112 are omitted. Accordingly, the bezel width can be reduced.

The display unit 250 can further include a flexible film 118 and a source printed circuit board (not illustrated).

The flexible film 118 is a film in which various components are disposed on a base film having a ductility. Specifically, the flexible film 118 is a film which supplies a signal to the plurality of sub pixels and the circuits of the active area AA and is electrically connected to the display panel 110. The flexible film 118 is disposed in a pad unit of the non-active area NA of the upper substrate 111 to supply a power voltage or a data voltage to the plurality of sub pixels and the circuits of the active area AA. In the meantime, the number of flexible films 118 can vary depending on the design, and is not limited thereto.

For example, a driving IC such as a data driver IC can be disposed on the flexible film 118. The driving IC is a component which processes a data signal for displaying images and a driving signal for processing the data signal. The driving IC can be disposed by a chip on glass (COG), a chip on film (COF), or a tape carrier package (TCP) depending on a mounting method.

The source printed circuit board is disposed on one end of the flexible film 118 to be connected to the flexible film 118. The source printed circuit board is a component which supplies signals to the driving IC. The source printed circuit board can supply various signals such as a driving signal or a data signal to the driving IC. For example, a data driving unit which generates data signals can be mounted in the source printed circuit board and the generated data signal can be supplied to the plurality of sub pixels and the circuit of the display panel 110 through the flexible film 118. The number of source printed circuit boards can vary depending on the design, but is not limited thereto.

In the meantime, a backlight unit which supplies light, a bottom cover 155 which accommodates the backlight unit and the display panel 110, and a guide panel 256 can be disposed below the display panel 110.

The backlight unit can include an LED array assembly including a light source which is accommodated in the bottom cover 155, a light guide plate 151, a reflective plate 153, a plurality of optical sheets 152, and a side reflective plate 154. The light guide plate 151 supplies a surface light source to the display panel 110 using the light source, the reflective plate 153 is disposed on a rear surface of the light guide plate 151, and the plurality of optical sheets 152 is disposed on a top surface of the light guide plate 151. Further, the side reflective plate 154 is disposed on a side surface of the light guide plate 151 excluding a lower side in which the LED array assembly is disposed. However, the backlight unit is not limited thereto.

The light source can be configured as an LED package 157 in which LEDs are mounted and can be disposed in a light incident area of the light guide plate 151. Further, the LED array assembly can include an LED package 157 and an LED printed circuit board 158.

As described above, the bottom cover 155 can be configured to include a lower portion 155a which supports the backlight unit and a side portion 155b which is vertically bent from the edge of the lower portion 155a. The side portion 155b of the bottom cover 155 can be bent in an “L” shape to accommodate the backlight unit.

Further, some configuration of the backlight unit is fixed by the guide panel 256 and the guide panel 256 can enclose and fix the side surfaces of the display panel 110 and the bottom cover 155.

The guide panel 256 can be formed to have a rectangular frame shape to have an inverted “L” shaped cross-section.

For example, the guide panel 256 of the second embodiment of the present disclosure can include a side portion 256a and a horizontal portion 256b. The side portion 256a is disposed on side surfaces of the display panel 110 and the bottom cover 155 to enclose the side surfaces of the display panel 110 and the bottom cover 155. The horizontal portion 256b extends between the display panel 110 and the optical sheet 152 from the side portion 256a to fix the optical sheet 152. At this time, the side portion 256a of the guide panel 256 can protrude vertically from the horizontal portion 256b so as to enclose the side surface of the display panel 110.

For example, the guide panel 256 according to the second embodiment of the present disclosure is formed such that the side portion 256a can protrude to be higher than the horizontal portion 256b in a vertical direction as compared with the first embodiment as described above, in consideration of the height of the foam pad 270 interposed between the display panel 110 and the guide panel 256. Further, a seating portion 256c with a predetermined depth in which the foam pad 270 is seated can be provided on the top surface of the horizontal portion 256b.

According to the second embodiment of the present disclosure, an edge of a rear surface of the display panel 110 can be seated in the seating portion 256c of the guide panel 256 by means of the foam pad 270.

The foam pad 270 can have a frame shape along left, right, upper, and lower edges of the display panel 110, but is not limited thereto. Referring to FIG. 6, the foam pad 270 can have left, right, upper, and lower sides which are separated, but is not limited thereto and can be configured with integrated left, right, upper, and lower sides.

Further, the foam pad 270 of the second embodiment of the present disclosure includes a first foam pad 270a provided on left, right, and upper sides of the display panel 110 and a second foam pad 270b provided on a lower side of the display panel 110. At this time, the lower side refers to a lower side of the display panel 110 on which the flexible film 118 is disposed.

The first foam pad 270a is provided on left, right, and upper sides of the display panel 110 and can be formed with a separated frame shape to have an L-shaped cross-section.

The first foam pad 270a of the second embodiment of the present disclosure can include a first side portion 270a′ and a first lower portion 270a″. The first side portion 270a′ is disposed on the side surface of the display panel 110 to enclose the side surface of the display panel 110 and corresponds to the side surfaces of the upper and lower substrates 111 and 112. The first lower portion 270a″ extends between the display panel 110 and the horizontal portion 256b of the guide panel 256 from the first side portion 270a′ to fix the display panel 110 to the horizontal portion 256b of the guide panel 256.

As described above, the first side portion 270a′ of the first foam pad 270a can seal the side surfaces of the upper and lower substrates 111 and 112.

For example, the first side portion 270a′ of the first foam pad 270a encloses the side surface of the display panel 110 and upwardly extends to be in contact with the light shielding layer 160. The first side portion 270a′ is interposed between the display panel 110 and the side portion 256a of the guide panel 256 to fix the display panel 110 to the side portion 256a of the guide panel 256.

For example, the first lower portion 270a″ of the first foam pad 270a extends between the display panel 110 and the horizontal portion 256b of the guide panel 256 from the first side portion 270a′ to be seated in the seating portion 256c of the guide panel 256. Further, the first lower portion 270a″ is interposed between the display panel 110 and the horizontal portion 256b of the guide panel 256 to fix the display panel 110 to the horizontal portion 256b of the guide panel 256.

The second foam pad 270b of the second embodiment of the present disclosure is provided below the display panel 110 and can be formed as a frame shape which is separated to have an L-shaped cross-section.

Further, the second foam pad 270b of the second embodiment of the present disclosure includes a second side portion 270b′ and a second lower portion 270b″. The second side portion 270b′ is disposed on the side surface of the lower substrate 112 to partially enclose the side surface of the lower substrate 112. The second lower portion 270b″ extends between the display panel 110 and the horizontal portion 256b of the guide panel 256 from the second side portion 270b′ to fix the display panel 110 to the horizontal portion 256b of the guide panel 256.

In the meantime, in the second foam pad 270b according to the second embodiment of the present disclosure, a height of the second side portion 270b′ can vary depending on the position. For example, the flexible film 118 is connected to the pad unit of the rear surface of the upper substrate 111. A part of the second side portion 270b′ of the second foam pad 270b in which the flexible film 118 is not disposed encloses the side surface of the lower substrate 112 and extends upwardly to be in contact with the upper substrate 111 (see FIG. 8A). In contrast, in the other part of the second side portion 270b′ of the second foam pad 270b in which the flexible film 118 is disposed, a part of the height is removed so that the second side portion 270b′ can be spaced apart from the upper substrate 111. That is, for example, the second side portion 270b′ of the second foam pad 270b can include an escape portion 271 through which the COF which is the flexible film 118 passes so that the top surface of the second side portion 270b′ can have a step.

One end of the flexible film 118 is connected to the pad unit of the rear surface of the upper substrate 111 and extends along the side portion 256a of the guide panel 256 so that the other end can be connected to the printed circuit board.

Further, the second lower portion 270b″ of the second foam pad 270b extends between the display panel 110 and the horizontal portion 256b of the guide panel 256 from the second side portion 270b′ to be seated in the seating portion 256c. That is, for example, the second lower portion 270b″ of the second foam pad 270b is interposed between the lower substrate 112 and the horizontal portion 256b of the guide panel 256 to fix the lower substrate 112 to the horizontal portion 256b of the guide panel 256.

Below the display panel, the pad 159 can be disposed between the horizontal portion 256b of the guide panel 256 and the optical sheet 152, but is not limited thereto.

In the meantime, according to the second embodiment of the present disclosure, a film type upper polarizer 114a is disposed on an uppermost layer of the display unit 250, instead of the cover glass, to reduce the overall thickness of the display device 100 to implement a slim design. Therefore, a slim and simple design can be implemented. Further, the cover glass is omitted to save the cost.

Further, according to the second embodiment of the present disclosure, the foam pad 270 is disposed between the display panel 110 and the guide panel 256 to improve the adhesive strength between the upper polarizer 114a and the guide panel 256.

Further, in the guide panel 256 according to the second embodiment of the present disclosure, a step thereon is removed and the upper polarizer 114a extends to the top of the guide panel 256 to remove the gap between the guide panel 256 and the upper polarizer 114a and reduce the width of the guide panel 256. Therefore, a step of the edge portion of the display unit 250 is removed while minimizing a width of a front edge to improve the aesthetics in terms of design. At this time, below the display panel 110, the upper polarizer 114a can extend to the upper portion of the front cover 135 which covers a part of the lower portion of the display panel 110.

As described above, the upper polarizer 114a according to the second embodiment of the present disclosure extends to the upper portion of the side portion 256a of the guide panel 256 by passing the first side portion 270a′ of the first foam pad 270a or extends to the upper portion of the front cover 135 by passing the side portion 256a of the guide panel 256. Therefore, the upper polarizer 114a can have an area larger than that of the display panel 110. Further, an upper step of the side portion 256a of the guide panel 256 is removed so that the gap between the upper polarizer 114a and the side portion 256a of the guide panel 256 can be removed. Accordingly, according to the present disclosure, four-side borderless can be implemented.

According to the second embodiment of the present disclosure, a colored light shielding layer 160 is formed on the edge of the rear surface of the upper polarizer 114a and a space between the display panel 110 and the guide panel 256 is filled with the foam pad 270 to block light which is leaked to the upper portion of the guide panel 256. Therefore, the aesthetics can be improved by suppressing the damage of the design due to the light leakage.

For example, the light shielding layer 160 has a frame shape along the edge of the rear surface of the upper polarizer 114a, but is not limited thereto.

In the meantime, according to the present disclosure, the light shielding layer can also be formed to extend toward a side surface of the display panel, which will be described in detail with reference to the drawings.

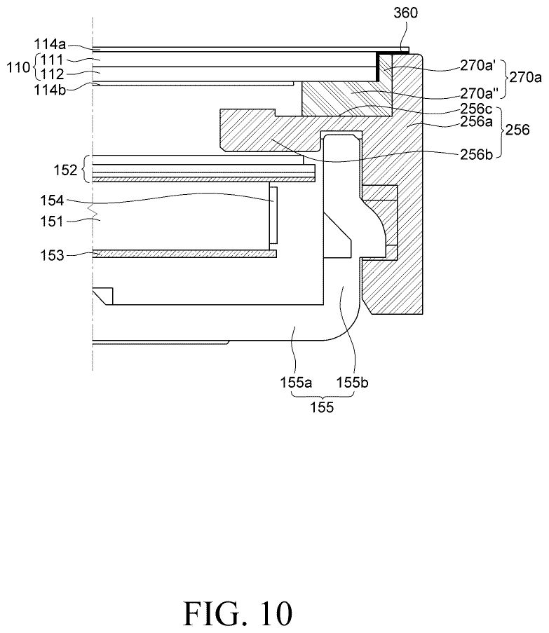

FIG. 10 is a cross-sectional view of a display device according to a third embodiment of the present disclosure.

The only difference or a main difference between the third embodiment of the present disclosure of FIG. 10 and the above-described second embodiment of FIGS. 5 to 9B is a formation position of a light shielding layer 360. However, the other configurations are substantially the same so that a redundant description will be omitted or may be briefly provided. Here, the description for the same reference numeral can refer to FIGS. 1 to 9B.

Referring to FIG. 10, according to the third embodiment of the present disclosure, the upper polarizer 114a can extend to the upper portion of the side portion 256a of the guide panel 256 by passing the first side portion 270a′ of the first foam pad 270a.

At this time, the colored light shielding layer 360 can be formed on the edge of the rear surface of the upper polarizer 114a.

The light shielding layer 360 can have a frame shape along the edge of the rear surface of the upper polarizer 114a, but is not limited thereto.

The light shielding layer 360 according to the third embodiment of the present disclosure can extend toward the side surface of the display panel 110, but is not limited thereto. For example, the light shielding layer 360 according to the third embodiment of the present disclosure can extend toward the rear surface of the display panel 110 so as to cover the edge of the rear surface of the upper polarizer 114a, a side surface and an edge of a rear surface of the display panel 110.

For example, the light shielding layer 360 can be formed by printing with black ink, but is not limited thereto.

As described above, according to the third embodiment of the present disclosure, a colored light shielding layer 360 is formed on the edge of the rear surface of the upper polarizer 114a and the side surface of the display panel 110 to completely block light which is leaked to the upper portion of the guide panel 256. Therefore, the aesthetics can be improved by suppressing the damage of the design due to the light leakage.

In the meantime, according to the present disclosure, a film, such as an optical film, is added onto the upper polarizer and the optical film extends to the upper portion of the guide panel, which will be described in detail with reference to the drawings.

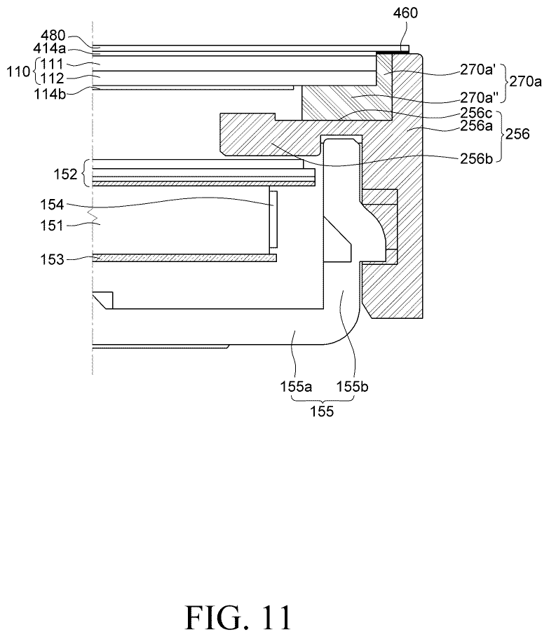

FIG. 11 is a cross-sectional view of a display device according to a fourth embodiment of the present disclosure.

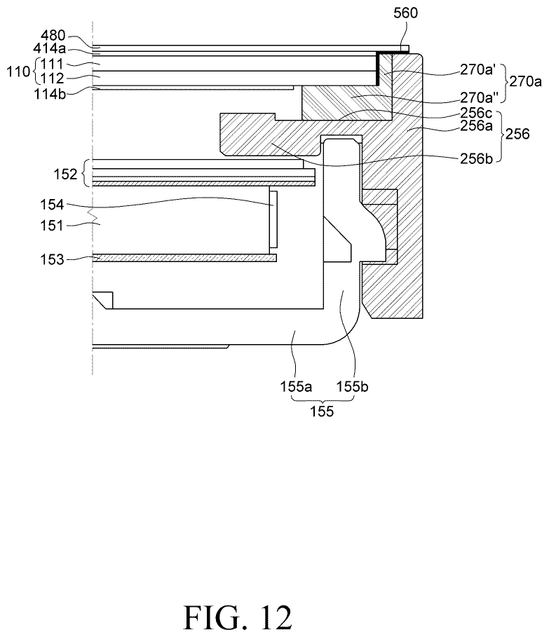

FIG. 12 is a cross-sectional view of a display device according to a fifth embodiment of the present disclosure.

The fourth embodiment and the fifth embodiment of FIGS. 11 and 12 are different from the second embodiment of FIGS. 5 to 9B and the third embodiment of FIG. 10 described above only in that an optical film 480 is added onto the upper polarizer 414a. However, the other configurations are substantially the same so that a redundant description will be omitted or may be briefly provided. Here, the description for the same reference numeral can refer to FIGS. 1 to 10.

Referring to FIGS. 11 and 12, the display panel 110 can be configured by upper and lower substrates 111 and 112 and a liquid crystal layer interposed between the upper and lower substrates 111 and 112.

Further, upper and lower polarizers 414a and 114b which selectively transmit only specific light can be attached onto an outer surface of the upper and lower substrates 111 and 112.

The upper polarizer 414a of the fourth and fifth embodiments of the present disclosure have a width and an area corresponding to the upper substrate 111, which is different from the above-described embodiments, but are not limited thereto.

According to the fourth and fifth embodiments of the present disclosure, the optical film 480 is additionally disposed on the upper polarizer 414a.

The optical film 480 can include at least one of a protection film, an anti-reflection film, and a luminance improvement film. At this time, the upper polarizer 414a and the optical film 480 can be referred to as an optical member.

According to the fourth and fifth embodiments of the present disclosure, the optical film 480 extends to the upper portion of the side portion 256a of the guide panel 256 by passing the first side portion 270a′ of the first foam pad 270a.

According to the fourth embodiment of the present disclosure, the colored light shielding layer 460 can be formed on the edge of the rear surface of the optical film 480.

The light shielding layer 460 can have a frame shape along the edge of the rear surface of the optical film 480, but is not limited thereto.

Further, according to the fifth embodiment of the present disclosure, the light shielding layer 560 can extend toward the side surface of the display panel 110, but is not limited thereto. For example, the light shielding layer 560 according to the fifth embodiment of the present disclosure can extend toward the side surface of the display panel 110 so as to cover the edge of the rear surface of the optical film 480 and a side surface of the display panel 110.

For example, the light shielding layers 460 and 560 can be formed by printing with black ink, but is not limited thereto.

As described above, according to the fourth and fifth embodiments of the present disclosure, the optical film 480 is additionally disposed on the upper polarizer 414a and the optical film 480 extends to the upper portion of the side portion 256a of the guide panel 256. Therefore, the protection, the suppression of the reflection, or luminance improvement of the upper polarizer 414a are possible and the overall thickness of the display device 100 is reduced to implement a slim design.

Further, according to the fourth and fifth embodiments of the present disclosure, a step of the upper side of the guide panel 256 is removed and the optical film 480 extends to the top of the guide panel 256 to remove the gap between the guide panel 256 and the optical film 480 and reduce the width of the guide panel 256. Therefore, a step of an edge portion of the display unit is removed while minimizing a width of a front edge to improve the aesthetics in terms of design.

Further, according to the fourth and fifth embodiments of the present disclosure, colored light shielding layers 460 and 560 are formed on an edge of a rear surface of the optical film 480 to block light which is leaked to the upper portion of the guide panel 256. Therefore, the aesthetics can be improved by suppressing the damage of the design due to the light leakage.

In the meantime, according to the present disclosure, a design of an upper portion of the guide panel is changed to suppress a damage applied to a polarizer or an optical film due to the external shock, which will be described in detail with reference to the drawings.

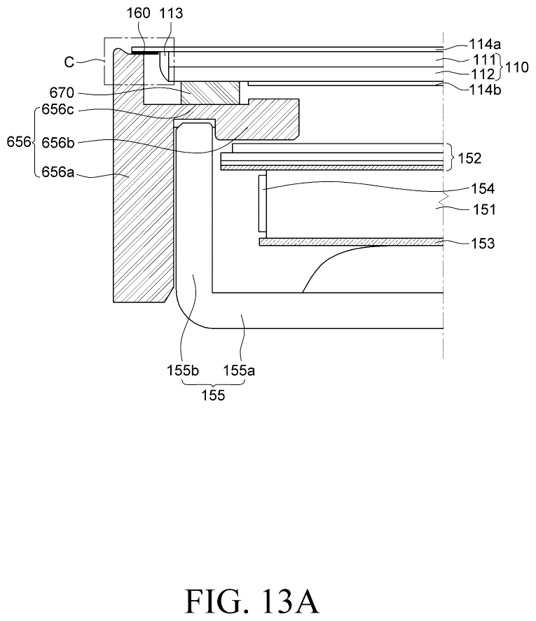

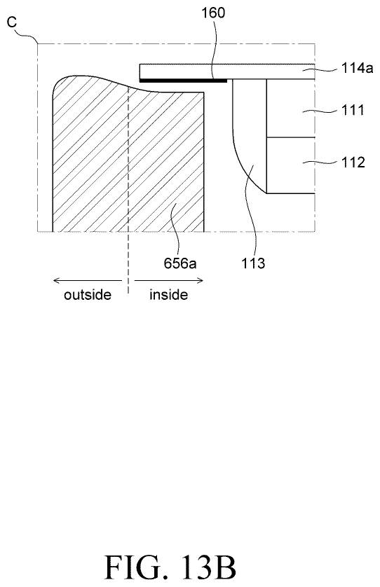

FIG. 13A is a cross-sectional view of a display device according to a sixth embodiment of the present disclosure. FIG. 13B is a view enlarging a part C of FIG. 13A.

The sixth embodiment of the present disclosure of FIGS. 13A and 13B is different from the above-described second embodiment of FIGS. 5 to 9B in that a design of an upper portion of a guide panel 656 is changed. However, the other configurations are substantially the same so that a redundant description will be omitted or may be briefly provided. Here, the description for the same reference numeral can refer to FIGS. 1 to 12.

Referring to FIGS. 13A and 13B, according to the sixth embodiment of the present disclosure, some configuration of the backlight unit is fixed by the guide panel 656 and the guide panel 656 can enclose and fix the side surfaces of the display panel 110 and the bottom cover 155.

The guide panel 656 according to the sixth embodiment of the present disclosure can be formed to have a rectangular frame shape to have an inverted “L” shaped cross-section.

For example, the guide panel 656 of the sixth embodiment of the present disclosure can include a side portion 656a and a horizontal portion 656b. The side portion 656a is disposed on side surfaces of the display panel 110 and the bottom cover 155 to enclose the side surfaces of the display panel 110 and the bottom cover 155. The horizontal portion 656b extends between the display panel 110 and the optical sheet 152 from the side portion 656a to fix the optical sheet 152. At this time, the side portion 656a of the guide panel 656 can protrude vertically from the horizontal portion 656b so as to enclose the side surface of the display panel 110. For example, the side portion 656a of the guide panel 656 can have a curvature to protrude to enclose the side surface of the display panel 110. Further, a seating portion 656c with a predetermined depth in which the foam pad 670 is seated can be provided on the top surface of the horizontal portion 656b of the guide panel 656.

Further, according to the sixth embodiment of the present disclosure, an upper cross-section of the side portion 656a of the guide panel 656 has a curved shape. For example, an upper cross-section of the side portion 656a of the guide panel 656 includes an inside and an outside and at least a part of the inside includes a flat surface and the outside can include a convex shape. For example, in the side portion 656a of the guide panel 656, a upper cross-section has a shape that goes inwardly from the top to the bottom at the inside and goes outwardly from the bottom to the top and then goes down again at the outside.

According to the sixth embodiment of the present disclosure, an edge of a rear surface of the display panel 110 can be seated in the seating portion 656c of the guide panel 656 by means of the foam pad 670.

The foam pad 670 can have a frame shape along the edge of the rear surface of the display panel 110, but is not limited thereto. The foam pad 670 has left, right, upper, and lower sides which are separated, but is not limited thereto and can be configured with integrated left, right, upper, and lower sides.

The foam pad 670 according to the sixth embodiment of the present disclosure can have a straight line shape disposed on the rear surface of the display panel 110, but is not limited thereto. The foam pad 670 of the present disclosure extends to the side surface of the display panel 110 to have an L-shaped cross-section.

In this case, the upper polarizer 114a can extend to the upper portion of the side portion 656a of the guide panel 656. The upper polarizer 114a can extend toward the inside of the side portion 656a of the guide panel 656. At this time, an outer upper portion of the side portion 656a of the guide panel 656 upwardly protrudes from the bottom surface of the upper polarizer 114a. Therefore, the upper polarizer 114a is guided by the protrusion on the outer upper portion of the side portion 656a of the guide panel 656 which upwardly protrudes during the assembly and can be fixed after the assembly. Further, the damage which is directly applied to the upper polarizer 114a due to the external shock is suppressed and the same shape appears externally to improve the aesthetics.

At this time, the colored light shielding layer 160 can be formed on the edge of the rear surface of the upper polarizer 114a.

The light shielding layer 160 can have a frame shape along the edge of the rear surface of the upper polarizer 114a, but is not limited thereto.

The light shielding layer 160 according to the sixth embodiment of the present disclosure can extend toward the side surface of the display panel 110, but is not limited thereto. For example, the light shielding layer 160 according to the sixth embodiment of the present disclosure can extend toward the rear surface of the display panel 110 so as to cover the edge of the rear surface of the upper polarizer 114a, an outside of a sealing member 113, and an edge of a rear surface of the lower substrate 112.

The embodiments of the present disclosure can also be described as follows:

According to an aspect of the present disclosure, there is provided a display device. The display device includes: a polarizer disposed on an uppermost layer of the display device; a display panel having a upper surface attached to the polarizer; a light shielding layer formed on an edge of a rear surface of the polarizer; a bottom cover disposed under the display panel and accommodating the display panel; and a guide panel disposed on a rear surface and a side surface of the display panel, wherein the guide panel includes a horizontal portion and a side portion, the horizontal portion protruding from the side portion, and wherein the polarizer extends to a top surface of the side portion of the guide panel.

According to embodiments of the present disclosure, the light shielding layer is further formed on the side surface of the display panel.

According to embodiments of the present disclosure, the light shielding layer extends between the display panel and the horizontal portion of the guide panel.

According to embodiments of the present disclosure, the display device further includes a sealing member provided on a side surface of the display panel.

According to embodiments of the present disclosure, the display device further includes an adhesive layer disposed between the light shielding layer and the top surface of the side portion of the guide panel.

According to embodiments of the present disclosure, the display device further includes a foam pad disposed between the display panel and the guide panel.

According to embodiments of the present disclosure, the foam pad includes a first foam pad provided on left, right, and upper sides of the display panel and a second foam pad provided on a lower side of the display panel.

According to embodiments of the present disclosure, a seating portion with a predetermined depth is provided on an upper surface of the horizontal portion of the guide panel, and the foam pad is seated in the seating portion.

According to embodiments of the present disclosure, the polarizer extends to a top surface of the foam pad.

According to embodiments of the present disclosure, the display device further includes a light source inside the bottom cover and a front cover which covers a part of a lower side of the display panel, wherein the polarizer extends to a top surface of the front cover.

According to embodiments of the present disclosure, the light shielding layer extends to the top surface of the front cover

According to another aspect of the present disclosure, there is provided a display device. The display device includes a display panel for displaying an image; a bottom cover disposed below the display panel; a guide panel surrounding side surfaces of the display panel and the bottom cover; an optical member positioned on a top surface of the display panel and extending above the guide panel; and a light shielding layer disposed on an edge of a rear surface of the optical member.

According to embodiments of the present disclosure, the optical member includes a polarizer.

According to embodiments of the present disclosure, an optical film is additionally disposed on the polarizer.

According to embodiments of the present disclosure, the guide panel includes: a side portion disposed on side surfaces of the display panel and the bottom cover to enclose side surfaces of the display panel and the bottom cover; and a horizontal portion extending between the display panel and the bottom cover from the side portion.

According to embodiments of the present disclosure, the horizontal portion protrudes from the side portion.

According to embodiments of the present disclosure, the guide panel includes a flat upper surface on which the optical member is mounted and a gap is not formed between the guide panel and the optical member.

According to embodiments of the present disclosure, an adhesive layer is disposed between a rear surface of an edge of the optical member and an upper surface of the side portion of the guide panel.

According to embodiments of the present disclosure, the light shielding layer has a frame shape along the rear surface of the edge of the optical member.

According to embodiments of the present disclosure, the display device further includes: a sealing member for sealing the side surface of the display panel, wherein the light shielding layer extends toward the side surface of the display panel so as to completely cover the outside of the sealing member.

According to embodiments of the present disclosure, the light shielding layer extends toward the rear surface of the display panel so as to cover the rear surface of the edge of the optical member, an outside of the sealing member, and a rear surface of an edge of the display panel.

According to embodiments of the present disclosure, the bottom cover includes a lower portion and a side portion which is bent vertically from an edge of the lower portion, and the light shielding layer extends toward the rear surface of the display panel to overlap the side portion of the bottom cover.

According to embodiments of the present disclosure, the light shielding layer extends toward the rear surface of the display panel so as to cover the rear surface of the edge of the optical member and a side surface and a rear surface of an edge of the display panel.

According to embodiments of the present disclosure, the display device further includes a foam pad which is interposed between the display panel and the guide panel in an L-shaped form.

According to embodiments of the present disclosure, a seating portion with a predetermined depth is provided to seat the foam pad on a top surface of the horizontal portion of the guide panel.

According to embodiments of the present disclosure, the foam pad is configured by a first foam pad provided on left and right sides and an upper side of the display panel and a second foam pad provided on a lower side of the display panel.

According to embodiments of the present disclosure, the first foam pad includes: a first side portion disposed on a side surface of the display panel; and a first lower portion which extends between the display panel and a horizontal portion of the guide panel from the first side portion to fix the display panel to the horizontal portion of the guide panel.

According to embodiments of the present disclosure, a first side portion of the first foam pad extends upwardly to be in contact with the light shielding layer, and the first side portion of the first foam pad is interposed between the display panel and the side portion of the guide panel to fix the display panel to the side portion of the guide panel.

According to embodiments of the present disclosure, a first lower portion of the first foam pad extends between the display panel and a horizontal portion of the guide panel from the first side portion to fix the display panel to the horizontal portion of the guide panel.

According to embodiments of the present disclosure, the display panel is configured to include an upper substrate and a lower substrate, and the second foam pad includes: a second side portion disposed on a side surface of the lower substrate; and a second lower portion which extends between the display panel and a horizontal portion of the guide panel from the second side portion to fix the display panel to the horizontal portion of the guide panel.

According to embodiments of the present disclosure, in the second foam pad, a height of the second side portion varies depending on a position for the display panel.

According to embodiments of the present disclosure, the display device further includes: a flexible film which is connected to a pad unit on a rear surface of the upper substrate, wherein a part of a second side portion of the second foam pad in which the flexible film is not disposed encloses a side surface of the lower substrate and extends upwardly to be in contact with the upper substrate, and wherein in the other part of the second side portion of the second foam pad in which the flexible film is disposed, a part of a height is removed so that the second side portion is spaced apart from the upper substrate.

According to embodiments of the present disclosure, an upper cross-section has a curved shape in the side portion of the guide panel.

According to embodiments of the present disclosure, the upper cross-section includes an inside and an outside in the side portion of the guide panel and the inside at least partially includes a flat surface and the outside includes a convex shape.

According to embodiments of the present disclosure, the guide panel includes a horizontal portion which extends between the display panel and the bottom cover from the side portion.

According to embodiments of the present disclosure, the optical member extends to the inside of the side portion of the guide panel.

According to embodiments of the present disclosure, an outer portion of the upper side of the side portion of the guide panel protrudes upwardly from the bottom surface of the optical member.

Although the embodiments of the present disclosure have been described in detail with reference to the accompanying drawings, the present disclosure is not limited thereto and can be embodied in many different forms without departing from the technical concept of the present disclosure. Therefore, the embodiments of the present disclosure are provided for illustrative purposes only but not intended to limit the technical concept of the present disclosure. The scope of the technical concept of the present disclosure is not limited thereto. Therefore, it should be understood that the above-described embodiments are illustrative in all aspects and do not limit the present disclosure. All the technical concepts in the equivalent scope of the present disclosure should be construed as falling within the scope of the present disclosure.

What is claimed is:

1. A display device comprising:
a polarizer disposed on an uppermost layer of the display device;
a display panel having a upper surface attached to the polarizer;
a light shielding layer disposed on an edge of a rear surface of the polarizer;
a bottom cover disposed under the display panel and accommodating the display panel; and
a guide panel disposed on a rear surface and a side surface of the display panel,
wherein the guide panel includes a horizontal portion and a side portion, the horizontal portion protruding from the side portion, and
wherein the polarizer extends to a top surface of the side portion of the guide panel.

2. The display device according to claim 1, wherein the light shielding layer is further disposed on the side surface of the display panel.

3. The display device according to claim 2, wherein the light shielding layer extends between the display panel and the horizontal portion of the guide panel.

4. The display device according to claim 1, further comprising a sealing member provided on the side surface of the display panel.

5. The display device according to claim 1, further comprising an adhesive layer disposed between the light shielding layer and the top surface of the side portion of the guide panel.

6. The display device according to claim 1, further comprising a foam pad disposed between the display panel and the guide panel.

7. The display device according to claim 6, wherein the foam pad includes:
a first foam pad provided on different sides of the display panel; and
a second foam pad provided on a lower side of the display panel.

8. The display device according to claim 6, wherein a seating portion with a predetermined depth is provided on an upper surface of the horizontal portion of the guide panel, and the foam pad is seated in the seating portion.

9. The display device according to claim 6, wherein the polarizer extends to a top surface of the foam pad.

10. The display device according to claim 1, further comprising a light source inside the bottom cover and a front cover which covers a part of a lower side of the display panel,
wherein the polarizer extends to a top surface of the front cover.

11. The display device according to claim 10, wherein the light shielding layer extends to the top surface of the front cover.

12. A display device comprising:
a display panel configured to display an image;
a bottom cover disposed below the display panel;
a guide panel surrounding side surfaces of the display panel and the bottom cover;
an optical member positioned on a top surface of the display panel and extending above the guide panel; and
a light shielding layer disposed on an edge of a rear surface of the optical member.

13. The display device according to claim 12, wherein the optical member includes a polarizer.

14. The display device according to claim 13, wherein an optical film is additionally disposed on the polarizer.

15. The display device according to claim 12, wherein the guide panel includes:
a side portion disposed on side surfaces of the display panel and the bottom cover to enclose side surfaces of the display panel and the bottom cover; and
a horizontal portion extending between the display panel and the bottom cover from the side portion of the guide panel.

16. The display device according to claim 15, wherein the horizontal portion of the guide panel protrudes from the side portion of the guide panel.

17. The display device according to claim 12, wherein the guide panel includes a flat upper surface on which the optical member is mounted, and a gap is not formed between the guide panel and the optical member.

18. The display device according to claim 15, wherein an adhesive layer is disposed between a rear surface of an edge of the optical member and an upper surface of the side portion of the guide panel.

19. The display device according to claim 12, wherein the light shielding layer has a frame shape along the rear surface of the edge of the optical member.

20. The display device according to claim 12, further comprising:
a sealing member configured to seal the side surface of the display panel,
wherein the light shielding layer extends toward the side surface of the display panel so as to completely cover an outside of the sealing member.

21. The display device according to claim 20, wherein the light shielding layer extends toward the rear surface of the display panel so as to cover the rear surface of the edge of the optical member, an outside of the sealing member, and a rear surface of an edge of the display panel.

22. The display device according to claim 21, wherein the bottom cover includes a lower portion and a side portion which is bent vertically from an edge of the lower portion, and
wherein the light shielding layer extends toward the rear surface of the display panel to overlap the side portion of the bottom cover.

23. The display device according to claim 12, wherein the light shielding layer extends toward the rear surface of the display panel so as to cover the rear surface of the edge of the optical member and a side surface and a rear surface of an edge of the display panel.

24. The display device according to claim 15, further comprising:
a foam pad interposed between the display panel and the guide panel in an L-shaped form.

25. The display device according to claim 24, wherein a seating portion with a predetermined depth is provided to seat the foam pad on a top surface of the horizontal portion of the guide panel.

26. The display device according to claim 24, wherein the foam pad is configured by a first foam pad provided on opposite sides and an upper side of the display panel and a second foam pad provided on a lower side of the display panel.

27. The display device according to claim 26, wherein the first foam pad includes:
a first side portion disposed on a side surface of the display panel; and
a first lower portion which extends between the display panel and a horizontal portion of the guide panel from the first side portion to fix the display panel to the horizontal portion of the guide panel.

28. The display device according to claim 27, wherein a first side portion of the first foam pad extends upwardly to be in contact with the light shielding layer, and
wherein the first side portion of the first foam pad is interposed between the display panel and the side portion of the guide panel to fix the display panel to the side portion of the guide panel.

29. The display device according to claim 27, wherein a first lower portion of the first foam pad extends between the display panel and a horizontal portion of the guide panel from the first side portion to fix the display panel to the horizontal portion of the guide panel.

30. The display device according to claim 26, wherein the display panel includes an upper substrate and a lower substrate, and
wherein the second foam pad includes:
a second side portion disposed on a side surface of the lower substrate; and
a second lower portion which extends between the display panel and a horizontal portion of the guide panel from the second side portion to fix the display panel to the horizontal portion of the guide panel.

31. The display device according to claim 30, wherein in the second foam pad, a height of the second side portion varies depending on a position for the display panel.

32. The display device according to claim 31, further comprising:
a flexible film connected to a pad unit on a rear surface of the upper substrate,
wherein a part of a second side portion of the second foam pad in which the flexible film is not disposed encloses a side surface of the lower substrate and extends upwardly to be in contact with the upper substrate, and
wherein in another part of the second side portion of the second foam pad in which the flexible film is disposed, a part of a height is removed so that the second side portion of the second foam pad is spaced apart from the upper substrate.

33. The display device according to claim 15, wherein an upper cross-section of the side portion of the guide panel has a curved shape.

34. The display device according to claim 33, wherein the upper cross-section includes an inside and an outside in the side portion of the guide panel, and
wherein the inside of the side portion of the guide panel at least partially includes a flat surface, and the outside of the side portion of the guide panel includes a convex shape.

35. The display device according to claim 33, wherein the guide panel includes a horizontal portion which extends between the display panel and the bottom cover from the side portion of the guide panel.

36. The display device according to claim 34, wherein the optical member extends to the inside of the side portion of the guide panel.

37. The display device according to claim 34, wherein an outer portion of the upper side of the side portion of the guide panel protrudes upwardly from the bottom surface of the optical member.
